(19) United States
(12) Patent Application Publication
(10) Pub. No.: US 2008/0170858 A1
(43) Pub. Date: Jul. 17, 2008

(54) Optical Pulse Source for Use in Broadband Photonic Communication Systems

(75) Inventors: Liam Barry, Dublin (IE); John Harvey, Auckland (NZ)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: DUBLIN CITY UNIVERSITY, Dublin 9 (IE)

(21) Appl. No.: 11/665,894

(22) PCT Filed: Oct. 21, 2005
(86) PCT No.: PCT/IE05/00118

§ 371 Date: Oct. 15, 2007

(30) Foreign Application Priority Data
Oct. 22, 2004 (IE) 2004/0705

(51) Int. Cl. H04J 14/02

(52) U.S. Cl. 398/87

(57) ABSTRACT

The invention relates to an apparatus and method for providing an improved optical pulse source suitable for use in high-speed optical communication systems. The optical pulse source can output spectrally pure pulses in a high capacity optical communication system. An optical pulse source in accordance with the invention comprises; at least one gain switched laser diode; and at least one non-linearly chirped optical processing element adapted to enhance the spectral purity of the output pulses generated from the laser diode.

### FIELD OF THE INVENTION

The present invention relates to optical pulse sources. More particularly, the invention relates to an apparatus and method for providing an improved optical pulse source suitable for use in high speed optical communication systems.

### BACKGROUND TO THE INVENTION

Optical networks are widely used in communication systems today. A typical optical network transmits data over a fibre optic cable by means of an optical transmitter. The data is transmitted over the cable as a series of light pulses.

As data traffic continues to increase, it is essential that optical networks can keep up with the demand. It will be necessary, in the near future, for many optical networks to be able to cope with data rates of 40 Gbits or more. As a result, service providers and carriers are constantly seeking methods to enhance network capacity and performance, while keeping costs to a minimum.

One commercial optical pulse source currently available for use in systems operating at 40 Gbit/s and beyond is based on mode locked laser diodes, as in PRITEL, U2t, and Gigatera sources. However mode locked laser diodes require a complex intra-cavity arrangement of the laser, which is a serious disadvantage. An alternative optical source which may be used is an externally modulated laser, such as JDSU and OKI sources. The drawback of this technique is that externally modulated lasers require additional components, which increases the overall cost of the system.

An optical technology which is suitable for sustaining high data rates is dense wavelength division multiplexing (WDM) technology. WDM systems enable a large number of wavelength channels, each carrying data, to be transmitted on one fibre. Each channel may operate for example at a bit rate of 10 Gbit/s, with a channel spacing of around 200 GHz, to achieve overall capacities approaching 1 Terabit/s. However, the majority of these systems use non-return-to-zero (NRZ) coding at the transmitter. In order to achieve line rates of 40 Gbit/s and higher, it is preferable to use return-to-zero (RZ) coding in place of NRZ coding. RZ (pulse) modulation formats offer a number of advantages over NRZ modulation schemes. For high-speed long haul systems, RZ modulation maintains signal integrity over longer distances as it travels through the network. Moreover, RZ formatting has a lower bit error rate and is far less susceptible to non-linearity and dispersion effects in the transmission fibre that can cause the signal to spread, thus rendering it unintelligible at the receiver. This is due to the use of optical pulses with specific peak power and pulse durations, which makes it possible to counterbalance the two detrimental effects of non-linearity and dispersion in the fibre, such that the data pulses (known as solitons) propagate undistorted.

Due to the potential benefits which a RZ WDM system could offer if used in high data rate optical transmission systems, this technique has been considered for providing a pulse source for high data rates. A rudimentary RZ pulse source arrangement could be generated simply by the use of a gain-switched laser diode. FIG. 1 shows a graph of the intensity and chirp of optical pulses versus time for an optical pulse generated simply by using an externally injected gain-switched laser. It can been seen that the pulse width for this circuit is approximately 18 ps.

One of the problems associated with this arrangement is that the direct modulation of the laser diode causes a time varying carrier density in the active region of the device, which in turn results in a variation in the output wavelength from the laser during the emission of the optical pulse. Consequently, different parts of the pulse are at different frequencies. This is known as a frequency chirp. A further drawback of this arrangement is that the generated data pulses are not suitable for high speed data transmission, as they are not compressed.

To be suitable for high speed data transmission, the pulse width should be compressed. This may be achieved by the use of a linear chirped optical filter in conjunction with a gain switched laser diode. In this arrangement, an amplified sine wave is applied to the laser together with a dc bias current. The dc bias is kept at a value that is less than the threshold of the laser. In this way, the carrier density within the laser is pushed above a certain threshold level, by the electrical signal, at which lasing occurs. A peak inversion point is then reached where the carrier density starts falling. The electrical signal is set so that it is short enough (i.e. the frequency of the sine wave is large enough) to bring down the carrier density before the oscillation of the optical power begins. As a result, very short optical pulses are generated.

The use of a linear chirped fibre grating, or dispersion compensating fibre also partially overcomes the problem of frequency chirp. Linear chirped gratings are adapted so that when the output pulses of a laser pass through the grating, those parts of the pulse having different frequencies are altered to travel at different speeds. Provided that the grating has been adapted to have the correct dispersion slope for the particular laser with which it is being used, this will result in the linear frequency chirp across the central part of the pulse being compensated, and the pulse being compressed. However, typically the wings of the pulse exhibit non-linear chirp. This is a result of is the gain-switching mechanism that occurs in the laser diode when it is modulated with a high power electrical sine wave. The frequency chirp across the gain-switched pulse is related to the carrier (electron) density in the active region of the laser, and the variation of this over the duration of the pulse is such that it is non-linear in the wings of the pulse, and linear in the centre of the pulse. Consequently, when the wings of the pulse are passed through the linear fibre grating temporal pedestals appear. This can be seen in FIG. 2, which shows a graph of the intensity and chirp of externally injected gain switched pulses after being reflected by a linearly chirped fibre grating. The non-linear chirp across the pulse is indicated by the dotted line. It will be appreciated that such differences in frequency across the pulses degrades the performance of these pulses when used in practical optical communication systems.

Therefore, the generated pulses in this arrangement lack spectral purity. As a result, this technique cannot generate pulses suitable for systems use.

U.S. Pat. No. 5,778,015 and its CIP U.S. Pat. No. 6,208,672, entitled “Optical Pulse Source” assigned to BT Ltd, disclose an optical pulse source which uses gain-switched optical pulses in conjunction with linearly chirped fibre gratings. In order to reduce the problems associated with the non-linear chirp across the gain-switched pulses, additional optical processing elements are also disclosed, namely an external modulator or a fibre loop mirror. The provision of these additional elements has the drawback of not only increasing the circuit complexity but also increasing the cost.

It will therefore be appreciated that there is a need to provide an improved optical pulse source suitable for use in high speed optical communication systems.

### OBJECT OF THE INVENTION

It is an object of the present invention to provide an improved apparatus and method for providing an optical pulse source suitable for use in high speed optical communication systems.

It is a further object of the invention to provide an optical pulse source that can output spectrally pure pulses in a high capacity optical communication system.

It is also an object of the invention to provide a high capacity optical pulse source of reduced circuit complexity, which is more robust and cost effective than prior art arrangements.

### SUMMARY OF THE INVENTION

The present invention provides an optical pulse source comprising:

At least one gain switched laser diode; and
At least one non-linearly chirped optical processing element adapted to enhance the spectral purity of the output pulses generated from the laser diode.

The non-linearly chirped optical processing element enhances the spectral purity by simultaneously compressing the pulses and reducing the frequency chirp of the pulses generated from the laser diode so as to provide high quality data pulses that are suitable to be used in high transmission rate systems.

Frequency chirp occurs when the direct modulation of the laser diode causes a time varying carrier density in the active region of the device, which in turn results in a variation in the output wavelength from the laser. As a result, different parts of the laser pulse are at different frequencies.

The compression of the pulses reduces the spectral width of the pulses so as to enable the pulses to be used in high speed data communications.

Advantageously, the spectral purity of the output pulses are enhanced by providing the optical processing element with a group delay profile which is the inverse to the group delay profile of the output pulses of the laser diode.

In order to obtain the inverse group delay profile, each value of the group delay profile of the output pulse is given the value which results from flipping this value about a horizontal axis which crosses the centre wavelength point of the group delay profile.

This means that when the pulse spectrum from the laser diode is passed through the adapted optical processing element, the resulting reflected signal has no group delay profile as a function of wavelength, and consequently no frequency chirp. This arrangement therefore produces an optical pulse source of excellent spectral and temporal purity.

Preferably the optical processing element operates in its reflective profile.

This ensures single moded operation of the laser (i.e. a high SMSR). It also means that when stable operation is achieved, the major part of the reflected signal is output to yield temporally and spectrally pure picosecond optical pulses.

Desirably, the optical processing element is a fibre bragg grating.

In accordance with one embodiment of the invention, the optical pulse source comprises one laser diode and a plurality of optical processing elements.

In another embodiment of the invention, the optical pulse source comprises a plurality of laser diodes and a plurality of non-linearly chirped optical processing elements.

The present invention also provides a method of increasing the data transmission rates in optical communication systems. The method comprises

enhancing the spectral purity of the output pulses of a laser diode by providing an optical processing element in the communication system and
setting the group delay profile of the optical processing element to be the inverse of the group delay profile of the output pulses of the laser diode.

Preferably, the group delay profile of the optical processing element is non-linear.

Desirably, the optical processing element is a fibre bragg grating.

The present invention also provides a method of producing an optical processing element for use in conjunction with a gain switched laser diode having output pulses. The method comprises the steps of:

determining the group delay profile of the output pulses of the laser diode; and
fabricating an optical processing element having a group delay profile that is the inverse to the group delay profile of the output pulses.

The step of determining the group delay profile of the output pulses may use the Frequency Resolved Optical Grating (FROG) technique.

The technique may comprise:

splitting an output pulse into two replicas with a relative temporal delay;
recombining the two replicas in an instanteously responding nonlinear medium so as to generate a nonlinear signal;
spectrally resolving each value of delay in order to yield a two dimensional time-frequency spectrogram;
recovering the intensity and phase values of the incident pulse using phase-retrieval techniques; and
determining from the intensity and phase values the group delay profile of the output pulse.

Desirably, the step of fabricating the optical processing element comprises generating a periodic variation in the refractive index of a fibre bragg grating which changes non-linearly across the fibre bragg grating.

The generation of the periodic variation in the refractive index may be carried out by writing UV rays into the fibre bragg grating.

### BRIEF DESCRIPTION OF THE DRAWINGS

FIG. 1 shows a graph of the intensity and chirp versus time of optical pulses generated from a prior art optical circuit having an externally injected gain-switched laser without the use of an optical processing element;

FIG. 2 shows a graph of the intensity and chirp versus time of externally injected gain switched pulses after they have been reflected through a linearly chirped optical processing element in a prior art optical circuit;

FIG. 3 shows a diagram of the optical pulse generation circuit in accordance with the present invention;

FIG. 4 shows a graph of the reflection and group delay profiles versus wavelength for a non-linearly chirped optical processing element of the present invention that has been fabricated using the FROG measurements determined from the gain-switched output pulse of a laser diode;

FIG. 5 shows a graph of the intensity and chirp versus time of externally injected gain switched pulses after they have been reflected through (a) a linearly chirped optical processing element of the prior art and (b) a non-linearly chirped optical processing element in accordance with the present invention;

FIG. 6 shows a graph of (a) the optical spectrum and (b) the oscilloscope trace of a compressed pulse after having been reflected through the non-linearly chirped optical processing element of the present invention; and

FIG. 7 shows a plot of the BER as a function of received optical power (a) a linearly chirped fibre gratings pulses of the prior art and (b) a non-linear chirped fibre grating of the present invention.

### DETAILED DESCRIPTION OF THE DRAWINGS

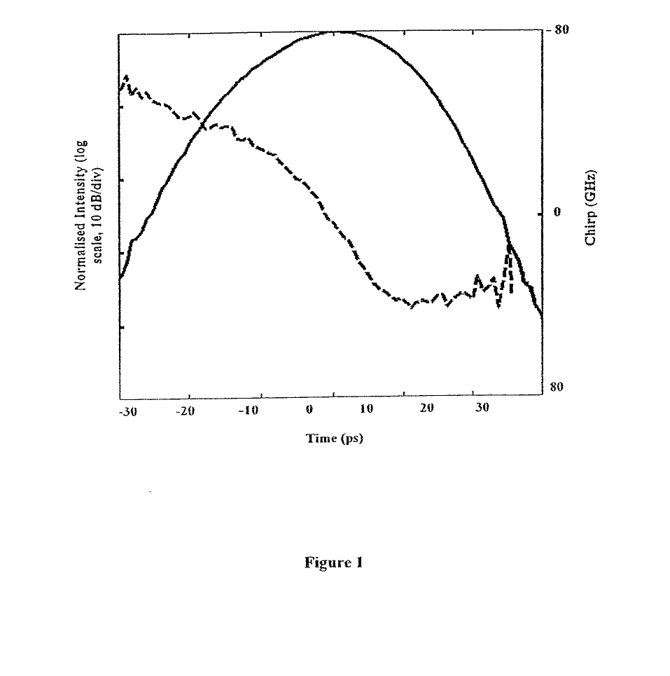

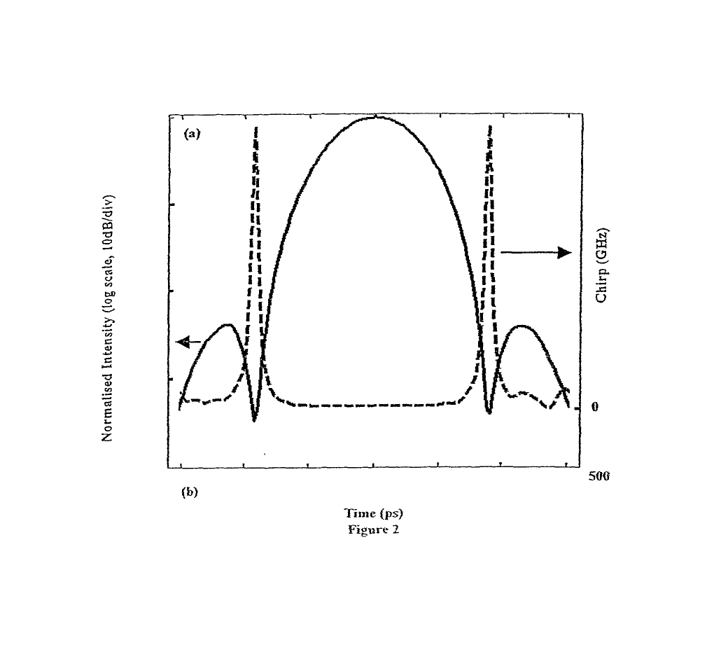

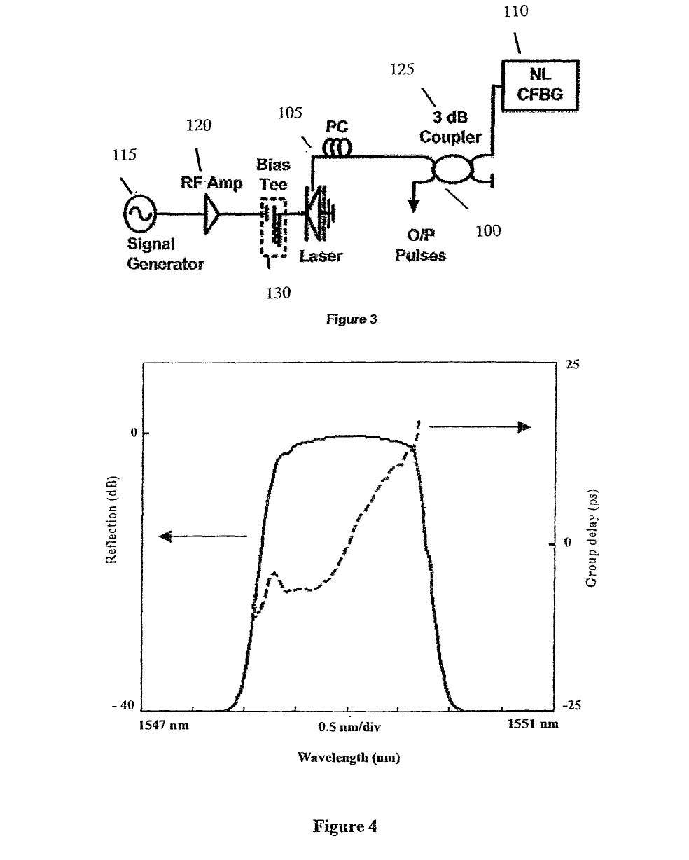

The present invention will now be described with reference to a preferred embodiment as shown in FIGS. 3 to 7. FIGS. 1 and 2 have previously been described with reference to the prior art.

FIG. 3 shows a diagram of the optical pulse generation circuit 100 in accordance with one embodiment the present invention. The optical pulse source comprises a gain switched laser diode 105 and an optical processing element 110 having a non-linear group delay or chirp.

In the embodiment of the invention shown in FIG. 3, the optical processing element is a non-linearly chirped Fibre Bragg Grating (NL CFBG) operating in its reflective profile. In accordance with the present invention, this filter has been adapted to enhance the spectral purity of the output pulse generated from the laser diode. As a result, optimal compression of the optical pulses output from the laser diode is achieved.

The laser diode is driven at its input by means of a signal generator 115 which is coupled to an amplifier 120. A dc bias current 130 is also input to the laser diode 105. A 3 db optical coupler or circulator 125 is provided between the output of the laser 105 and the optical processing element 110.

As discussed in the background to the invention section, the output pulses of a typical gain switched laser diode exhibit a non-linear frequency chirp. i.e. the pulses have an optical spectrum with a non-linear group-delay. In order to provide a high quality data signal, the non-linear frequency chirp of the output pulses from the laser diode must be reduced. In addition, in order to provide a high data rate, the width of the pulse needs to be compressed so that the data pulses may be used in high bit-rate communications systems, such as Optical Time Division Multiplexed Systems without causing overlap of the pulses.

By altering the characteristics of the output pulse of the laser diode so as to have no group delay as function of wavelength, a transform limited pulse (i.e. a spectrally pure pulse) may be obtained.

In accordance with the present invention, this is achieved by adapting the optical processing element so as to provide a group delay profile which is opposite (i.e. the inverse) to the group delay profile of the gain switched pulse output of the laser diode. The group delay profile is the relative temporal delay between the different frequency (wavelength components) of the pulse. If the optical processing element is adapted to provide a group delay profile inverse to the group delay profile of the output pulses of the laser diode, when the pulse spectrum from the laser diode is reflected through the adapted optical processing element, the resulting reflected signal has no group delay profile as a function of wavelength, and consequently no frequency variation as a function of time in the temporal domain (where the group delay profile in the spectral domain is equivalent to the frequency chirp in the temporal domain, the conversion between the two being carried out via the Fourier Transform). This arrangement therefore produces an optical pulse source of excellent spectral and temporal purity.

The non-linear chirped fibre grating is also adapted so that it has a chirp profile which ensures that the leading edge of the pulse (at certain optical frequencies) travels slower that the trailing edge of the pulse (at different optical frequencies), thus resulting in compression of the pulse, which is required for high speed data transmission.

In order to fabricate an optical processing element with a group delay profile opposite to the group delay profile across the gain switched pulse, the optical pulses output from the laser diode must first be characterised. In accordance with one embodiment of the present invention, the characterisation of the optical pulses is carried out using a technique known as Frequency Resolved Optical Grating (FROG). This technique enables the exact frequency shift and non linear group delay profile across the generated pulses to be determined.

FROG is a technique used to characterise ultrashort pulses. It has been applied both to the optinisation and characterisation of optical pulse sources. In this technique, an incident ultrashort pulse is split into two replicas with a relative temporal delay. The two replicas are then recombined in an instaneously responding nonlinear medium. The overlapping pulses generate a nonlinear signal which is spectrally resolved for each value of delay in order to yield a two dimensional time-frequency spectrogram, known as a FROG trace. The intensity and phase (i.e. the complete electric field) of the incident pulse is then recovered from the FROG trace by application of phase-retrieval techniques either using FROG or another suitable measuring device. From this measurement, the non-linear chirp (temporal domain measurment) and the non-linear group delay (spectral domain measurement) may be determined. By flipping (inverting) the group delay of the measured pulse, the group delay of the optical processing element necessary to correctly generate transform limited pulses is obtained.

In practice, a dedicated piece of hardware performs the FROG technique. To obtain a measurement, the output pulses from the laser diode are fed to the input ports of the FROG device. The device may then calculate the frequency chirp and the group delay of the pulses. Once this information is obtained, a mathematical software package such as MATLAB may be used to carry out the inversion of the group delay or frequency chirp. This involves flipping each point in the measured group delay (frequency chirp) about a centre wavelength (time) point. i.e. each measured value is given the value which results from flipping this value about a horizontal axis which crosses the centre wavelength point of the group delay profile. For example, if the centre wavelength point for the group delay profile occurred at Ops, a group delay value of −10 ps would be inverted to +10 ps, while a group delay value of −5 ps would be inverted to a value +5 ps, and so on for each value of the group delay profile.

Once the required non-linear group delay profile of an optical processing element for use with a specific laser has been determined, an optical processing element in the form of a fibre grating having this group delay profile is fabricated. This may be carried out using Ultra Violet “writing” technology, or any other suitable technology, which generates a variation in the refractive index in the fibre grating proportional to the required group delay profile.

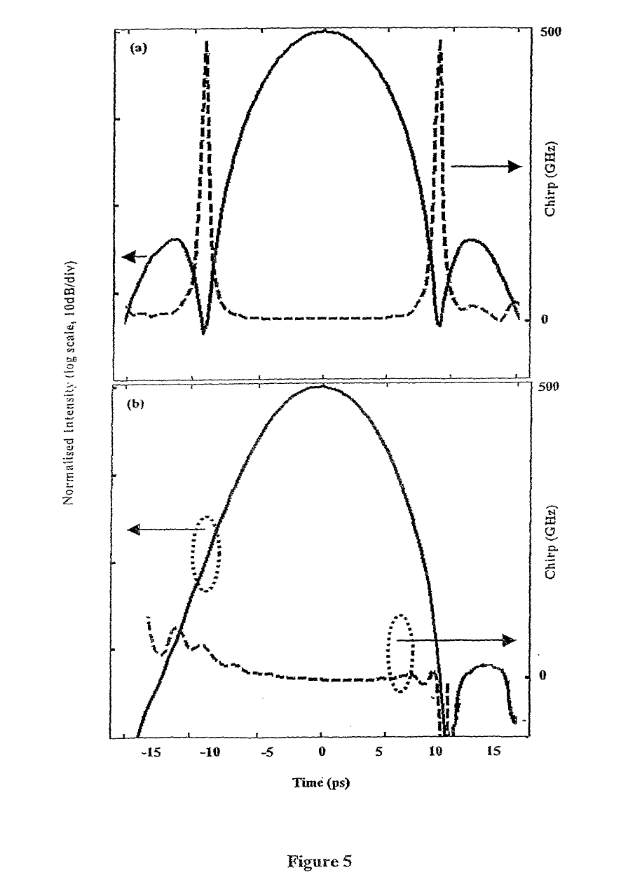

In prior art fibre gratings, the fabrication technique would involve writing a linear variation of the periodic refractive index in the fibre grating. This would result in a linear fibre grating. However, in the case of the present invention, the fibre grating is required to have a non-linear group delay profile. Therefore, the periodic refractive index of the fibre grating is varied slightly (non-linearly) across the length of the fibre grating, in order to obtain a fibre grating with the required non-linear group delay. FIG. 4 shows a graph of the reflection and group delay profiles of an exemplary non-linearly chirped fibre grating that has been fabricated using the FROG measurements.

Once the optical processing element has been adapted for use with a specific laser, the circuit of the present invention will generate spectrally pure optical pulses. In use, as shown in the circuit of FIG. 3, a sine wave from the signal generator 115 is electrically amplified in amplifier 120. The amplified sine wave is then applied to the laser 105 in conjunction with a dc bias current 130 so as to generate a gain switched laser diode. The dc bias is kept at a value that is less than the threshold of the laser. In this way, the carrier density within the laser is pushed above a certain threshold level by the electrical signal at which lasing occurs. A peak inversion point is then reached where the carrier density starts falling. The electrical signal should be set so that it is short enough (i.e. the frequency of sine wave large enough) to bring down the carrier density before the oscillation of the optical power begins. As a result, very short optical pulses are generated.

The output pulses are then passed through the 90:10 passive optical coupler 125 into the non-linearly chirped Fibre Bragg Grating (FBG) 110 having a group delay profile opposite to the output pulse of the laser. The FBG is used in its reflective profile. As a result, the output pulses generated from the laser diode are reflected off the grating.

The function of the FBG in this profile maybe twofold. Firstly a tenth of the reflected signal is sent back into the laser, which ensures single moded operation of the laser (i.e. a high SMSR). Secondly, when stable operation is achieved, the major part of the reflected signal is output to yield temporally and spectrally pure picosecond optical pulses. As a result, when the output pulses of the laser diode are reflected from the non-linear grating, the resulting pulses will be transform limited with excellent spectral and temporal purity. Improved SMSR may also be achieved by using external injection from a second source into the gain-switched laser.

It should be noted that it is typically necessary to perform the characterisation of the group delay profile of the output pulses for each individual laser, in order to determine the optimal parameters (i.e. group delay profile) for the optical processing element to be used in conjunction with a specific laser. This is due to the fact that each laser when gain switched produces slightly different pulses with different frequency chirps.

In a further embodiment of the invention, a multi-wavelength pulse source is provided which is suitable for use in wavelength tuneable WDM systems. In this embodiment, the design of the non linear optical processing element is altered to ensure that it operates over a range of wavelength bands, and in each wavelength band the group delay of the optical processing element is designed to compensate for the non-linear chirp of the output pulses generated from a laser diode. In one embodiment of the invention this could be achieved by providing a series of optical processing elements arranged in cascade. Each of the optical processing elements would be adapted to reflect light of a particular wavelength, while allowing light of other wavelengths through, and to have a group delay profile inverse to the group delay profile of the output pulse for that particular wavelength. The laser diode could be for example a multi-wavelength laser diode, or alternatively a number of separate laser diodes, each generating an output pulse of a different wavelength.

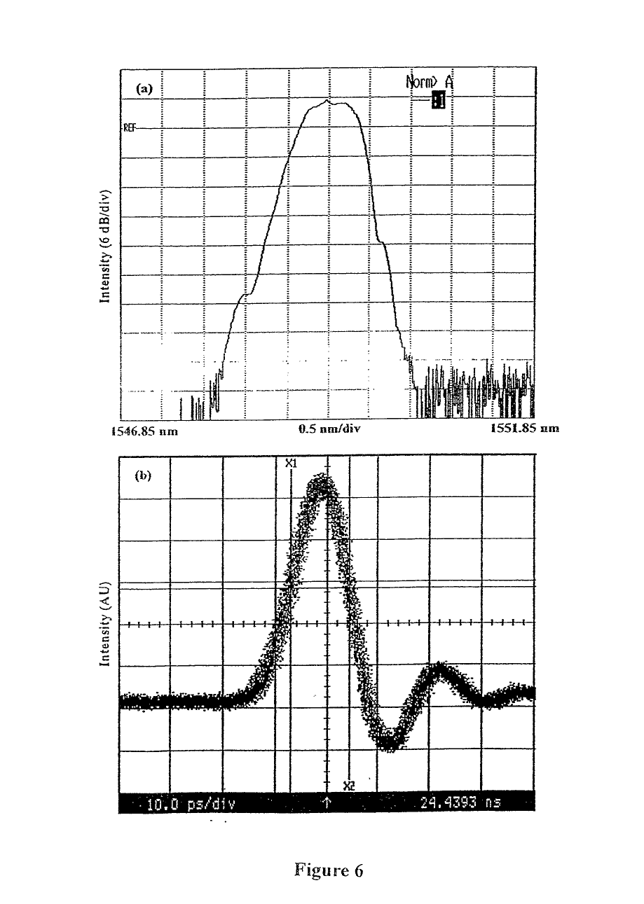

A comparison of the performance of the optical pulse source of the present invention with prior art optical pulse sources shows a significant improvement in the quality of the data pulses generated by the circuit of the present invention. This can be seen from the graphs of FIGS. 5 and 6.

FIG. 5 shows a graph of the intensity and chirp versus time of externally injected gain switched pulses after being reflected by (a) a linearly chirped and (b) a non-linearly chirped optical processing element in the form of a fibre bragg grating. It should be noted from the graph (b) for the non-linear optical processing element that the compressed pulse is approximately 7 ps duration, which is much more desirable that the duration of the prior art non-compressed pulse shown in FIG. 1. Furthermore, the frequency chirp across the pulse is almost negligible (i.e. the pulses are transform limited). This is in contrast to the graph of the pulse when reflected through the linearly chirped optical processing element shown in graph (a), which exhibits significantly higher frequency chirp. It will therefore be appreciated that the non-linear optical processing element provides optimum compression of the gain-switched pulses. In addition, it prevents the growth of pedestals on either side of the pulse when compared with the linearly chirped optical pulse of graph (a).

FIG. 6 shows a graph of (a) the optical spectrum and (b) the oscilloscope trace of the pulse after being reflected through the non-linearly chirped optical processing element of the present invention. It can be seen that there is little or no noise beside the spectrum, and also noise floor is down about 60 dB from pulse maximum. It is clear from an examination of these graphs that this circuit produces pulses of high spectral purity.

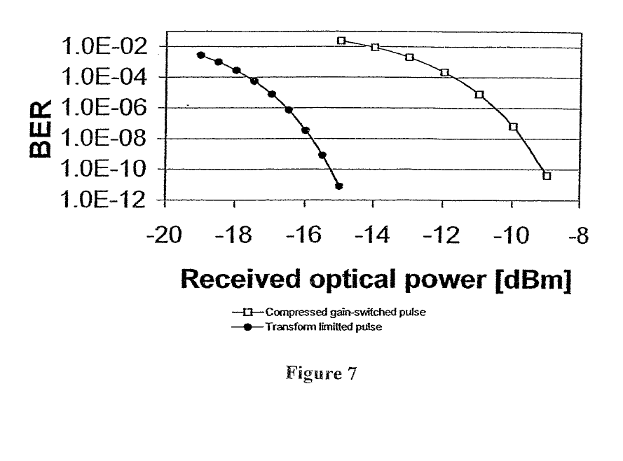

To demonstrate the performance of these optimised pulses in an actual communication system, simulations were carried out using Virtual Photonics Incorporated (VPI). This provided an insight into system penalties introduced by poor Temporal Pedestal Suppression Ratio (TPSR), as would be achieved for pulse sources in which the non-linear chirp is not correctly compensated. Two 40 Gb/s OTDM systems were built, one based on linearly compressed 8 ps gain switched pulses and the other employing 8 ps transform limited gaussian pulses (as would be achieved with a non-linear chirped fibre grating after the gain-switched pulses). The former exhibited a TPSR of ˜20 dB due to the uncompensated non-linear chirp in the wings of the pulse. The latter on the other hand portrayed an excellent TPSR of over 40 dB. It will be appreciated from the graph of FIG. 7 showing a plot of the BER as a function of received optical power for both the linear chirped grating and the non-linear chirped grating, that the system employing gain switched pulses compressed using linearly chirped fibre gratings incurs a power penalty of 6 dB (@BER of 10⁻⁹) in comparison to the system that uses transform-limited pulses.

It will therefore be appreciated that the optical pulse source of the present invention has numerous advantages over prior art optical sources. Firstly, gain-switching is a direct modulation technique which requires no additional cavity. The use of a non-linearly chirped optical processing element in conjunction with the gain-switching pulse generation technique removes the problem associated with using this technique in prior art systems, namely the lack of spectral and temporal purity. The present invention yields nearly transform limited (i.e the minimal spectral width required) pulses. The excellent spectral and temporal purity enables a high capacity optical communication system using OTDM and hybrid WDM/OTDM technologies to be implemented. Furthermore, due to the simplicity of the design, the present invention provides a much more robust and cost efficient means of transmitting optical pulses in 40 Gbit/s transmission systems when compared with existing technologies.

The words “comprises/comprising” and the words “having/including” when used herein with reference to the present invention are used to specify the presence of stated features, integers, steps or components but does not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1. An optical pulse source comprising:
at least one gain switched laser diode; and
at least one non-linearly chirped optical processing element adapted to enhance the spectral purity of the output pulses generated from the laser diode.

2. An optical pulse source as claimed in claim 1, wherein the spectral purity of the output pulses are enhanced by providing the optical processing element with a group delay profile which is the inverse to the group delay profile of the output pulses of the laser diode.

3. An optical pulse source as claimed in claim 1, wherein the optical processing element operates in its reflective profile.

4. An optical pulse source as claimed in claim 1, wherein the optical processing element is a fibre bragg grating.

5. An optical pulse source as claimed in claim 1, characterised in that the optical pulse source comprises one laser diode and a plurality of optical processing elements.

6. An optical pulse source as claimed in claim 1, characterised in that the optical pulse source comprises a plurality of laser diodes and a plurality of non-linearly chirped optical processing elements.

7. A method of increasing the data transmission rates in optical communication systems comprising:
enhancing the spectral purity of the output pulses of a laser diode by providing an optical processing element in the communication system and
setting the group delay profile of the optical processing element to be the inverse of the group delay profile of the output pulses of the laser diode.

8. The method of claim 7, wherein the group delay profile of the optical processing element is non-linear.

9. The method of claim 7, wherein the optical processing element is a fibre bragg grating.

10. A method of producing an optical processing element for use in conjunction with a gain switched laser diode having output pulses, the method comprising the steps of:
determining the group delay profile of the output pulses of the laser diode; and
fabricating an optical processing element having a group delay profile that is the inverse to the group delay profile of the output pulses.

11. The method of claim 10, where in the step of determining the group delay profile of the output pulses uses the Frequency Resolved Optical Grating (FROG) technique.

12. The method of claim 11, wherein the technique comprises:
splitting an output pulse into two replicas with a relative temporal delay;
recombining the two replicas in an instaneously responding non linear medium so as to generate a non linear signal;
spectrally resolving each value of delay in order to yield a two dimensional time-frequency spectrogram;
recovering the intensity and phase values of the incident pulse using phase-retrieval techniques; and determining from the intensity and phase values the group delay profile of the output pulse.

13. The method of claim 10, wherein the step of fabricating the optical processing element comprises generating a periodic variation in the refractive index of a fibre bragg grating which changes non-linearly across the fibre bragg grating, the variation in the refractive index being proportional to the group delay profile of the output pulse.

14. The method of claim 13, wherein the generation of the periodic variation in the refractive index is carried out by writing UV rays into the fibre bragg grating.

15. (canceled)
